(19) United States
(12) Patent Application Publication
(10) Pub. No.: US 2010/0287106 A1
(43) Pub. Date: Nov. 11, 2010

(54) Actionable Business Intelligence System and Method

(75) Inventors: Gerrit Joseph Halkus, Capelle a/d IJssel (NL); Willem Machiel Jongsma, Capelle a/d IJssel (NL)

Correspondence Address: FLIESLER MEYER LLP, 650 CALIFORNIA STREET, 14TH FLOOR, SAN FRANCISCO, CA, 94108, US

(73) Assignee: DEXTON SOFTWARE CORPORATION SARL, Luxembourg (LU)

(21) Appl. No.: 12/671,007

(22) PCT Filed: Dec. 13, 2007
(86) PCT No.: PCT/NL07/50648

§ 371 Date: May 4, 2010

(30) Foreign Application Priority Data
Jul. 27, 2007 (EP) 07113333.4

(51) Int. Cl. G06Q 10/00

(52) U.S. Cl. 705/301

(57) ABSTRACT

The invention relates to system (200) for analyzing and controlling a business process, comprising a software platform (201) for supporting at least one business intelligence module (107). The software platform (201) is arranged to provide an interface between a user and the at least one BI module (107). The system further comprises an integration module (204) arranged to communicate with the software platform (201) and with the at least one business intelligence module (302). The integration module (204) is also arranged to: extract business data from at least one business data storage (102) source; offer the business data to the at least one business intelligence module (107); receive a command from the software platform (201) or from the business intelligence module (107) indicating that the user asked for action to decrease a difference between a value of a business target parameter and a value of a realization parameter; create one or more appropriate business actions to decrease the difference using business rules already provided by the user; communicate the one or more business actions to at least one business software application, such as an ERP application, in charge of the at least one business data storage.

### TECHNICAL FIELD

The present invention relates to a system and method for analyzing and controlling a business process.

### BACKGROUND

The term business intelligence (BI) refers to technologies, applications, and practices for the collection, integration, analysis, and presentation (i.e. reporting) of business information and also sometimes to the information itself The purpose of business intelligence is to support better business decision-making. BI describes a set of concepts and methods to improve business decision making by using fact-based support systems. BI is sometimes used interchangeably with briefing books, report and query tools and executive information systems. Business Intelligence systems are data-driven DSS. BI systems provide historical, current, and predictive views of business operations, most often using data that has been gathered into a data warehouse. This data warehouse is loaded by an ETL tool that applies a series of rules or functions to data extracted from particular data sources of business software applications.

A BI application enables signaling differences in planning and actuals but neither the BI application nor the present ETL tools can automatically incorporate the findings (of the differences) into daily business processes.

### SUMMARY OF THE INVENTION

It is a goal of the present invention to provide a system and method for analyzing and controlling business processes where once a user has identified a problem, proper business actions are automatically generated and processed.

This goal is achieved by a system for analyzing and controlling a business process, comprising:

a software platform for supporting at least one business intelligence module, the software platform being arranged to provide an interface between a user and the at least one BI module;

an integration module arranged to communicate with the software platform and with the at least one business intelligence module, the integration module being arranged to:

extract business data from at least one business data storage source;

offer the business data to the at least one business intelligence module;

receive a command from the software platform or from the business intelligence module indicating that the user asked for action to decrease a difference between a value of a business target parameter and a value of a realization parameter;

create one or more appropriate business actions to decrease the difference using business rules already provided by the user;

communicate the one or more business actions to at least one business software application, such as an ERP application, in charge of the at least one business data storage.

The system according to the invention provides for what is referred to as ‘Actionable Business Intelligence’ (Actionable BI). Actionable BI means that structured actions are taken from within a BI analysis application which actions are linked to actual and predefined business processes. Actionable BI allows the user to identify a problem and immediately act upon it from within a single BI application.

In an embodiment, the business actions are communicated to the business software applications by means of XML data files, XML data streams, CSV files and/or ADO/ODBC.

In a further embodiment, the software platform comprises a GUI component arranged to display the difference between a value of a business target parameter and a value of a realization parameter, and to receive a command from the user.

The invention also relates to a method for analyzing and controlling a business process, comprising:

provide a software platform to support at least one BI module;

provide an interface between a user and the at least one BI module;

extract business data from at least one business data storage source;

offer the business data to the at least one business intelligence module;

receive a command from the or from the business intelligence module indicating that a user asked for action to decrease a difference between a value of a business target parameter and a value of a realization parameter;

create one or more appropriate business actions to decrease the difference using business rules already provided by the user;

communicate the one or more business actions to at least one business software application, such as an ERP application, in charge of the at least one business data storage.

The invention finally relates to a computer program product tangibly embodied in an information carrier, the product including instructions that, when executed, perform the method described above.

### BRIEF DESCRIPTION OF THE DRAWINGS

The present invention will be discussed in more detail below, using a number of exemplary embodiments, with reference to the attached drawings, in which:

FIG. 1 schematically shows a diagram of a state of the art business analysis system;

FIG. 2 schematically shows a diagram of an example of a business analysis system according to an embodiment;

FIG. 3 shows the main components of the Integrator according to an embodiment;

FIG. 4 shows an example of a screen produced by the GUI of the software platform;

FIG. 5 shows an example of the screen with a situation in which the user has selected the context ‘Charter’;

FIG. 6 shows a screen in a situation where the user has dragged an Interest component onto the main section of the screen;

FIG. 7 shows the screen in which KPI-icons are displayed related to particular KPI's;

FIG. 8 is a flow chart showing a procedure performed by the system according to an embodiment of the invention.

### DETAILED DESCRIPTION OF EXEMPLARY EMBODIMENTS

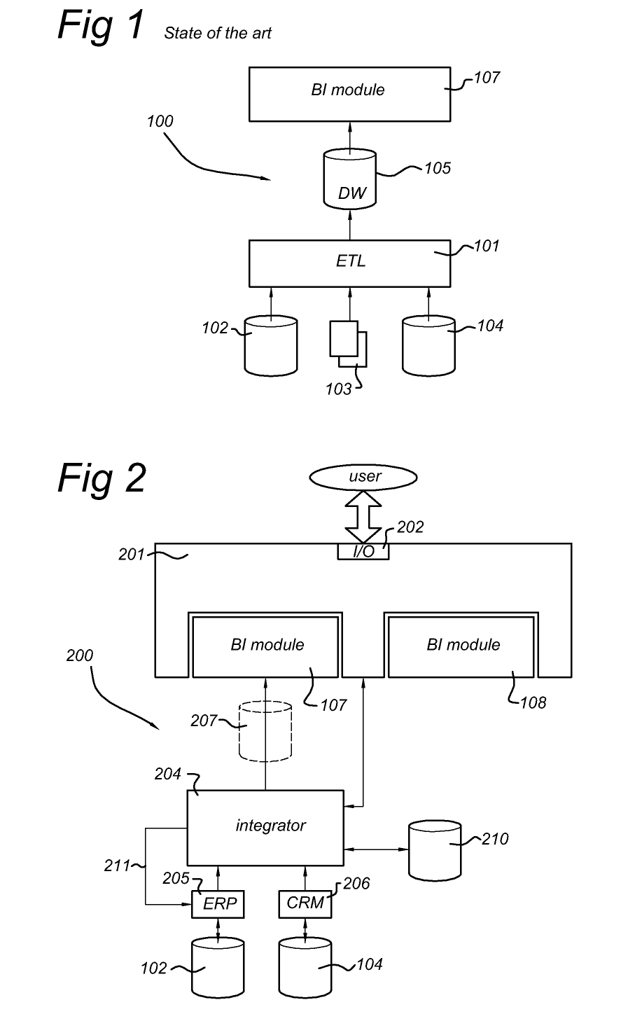

FIG. 1 schematically shows a diagram of a state of the art business analysis system 100. The system 100 comprises an Extract Transform and Load (ETL) tool 101 which extracts data from one or more data sources 102, 103, 104. Each separate data source may use a different data organization/format. Examples of such data sources are relational databases and flat files, but may include non-relational database structures such as IMS or other data structures such as VSAM or ISAM. The ETL tool 101 converts the data from the data sources 102, 103, 104 into a format for a transformation stage. In this transformation stage, the ETL tool 101 applies a series of rules or functions to the extracted data from the data sources 102, 103, 104 to derive the data to be loaded to an end target, such as a data warehouse (DW) 105. Some data sources will require very little or even no manipulation of data. In other cases, one or more of the following transformations types to meet the business and technical needs of the end target may be required. The data warehouse 105 might regularly (e.g. weekly) overwrite existing information with cumulative, updated data.

In this example, the business analysis system 100 also comprises a BI module 107 implemented by a software program arranged to produce business reports. These business reports may be used by business managers who need this information for e.g. decision making. The BI module 107 uses data stored at the data warehouse 105. The BI module 107 can retrieve data from the data warehouse 105, but it does not update the data warehouse 105. The data warehouse 105 is only updated by the ETL tool 101. The state of the art BI module 107 may be arranged to enable a user to form his own database if needed. However, such a user is never authorized to write back into the original data sources 102, 103, 104 owned by the business software applications. This would make the data in these data sources 102, 103, 104 unverifiable.

FIG. 2 schematically shows a diagram of an example of a system 200 for analyzing and controlling a business process according to an embodiment of the invention. The system 200 for analyzing and controlling a business process is also referred to as ‘business analysis system 200’. The business analysis system 200 comprises a platform 201 also referred to as Agile System Environment (ASE) 201, which is arranged to support and interact with several BI modules such as the BI module 107 mentioned above. The ASE platform 201 has an I/O module 202 that is arranged to provide an interface to the user of the business analysis system 200. The business analysis system 200 also comprises an integrating module 204. The integrating module 204, also referred to as Integrator 204, is arranged to communicate with the ASE platform 201. The Integrator 204 is the technical engine of the business analysis system 200 and integrates all the various BI modules 107, 108 connected to the ASE platform 201.

The Integrator 204 is arranged to retrieve data from the data sources 102, 103, 104 and manipulate the data. This is why the Integrator 204 can best be regarded as being an ETL tool except for the data storing into a data warehouse. After retrieving data from one or more databases 102, 104, the Integrator 204 stores it into a memory, such as RAM. The Integrator 204 is arranged to perform data manipulation on data present in this memory. The Integrator 204 can perform calculations on data in its memory, combine several data sources and offer the adjusted manipulated data to the BI modules 107, 108. The BI modules 107, 108 experience the data stored in a memory by the Integrator 204 as a so-called Virtual database 207, see FIG. 2. The Integrator 205 is arranged to store relevant business data into the memory 207 (i.e. virtual database) whenever the BI modules 107, 108 request for the data. Contrary to present data warehouses regularly filled by an ETL tool, the virtual database 207 will contain up-to-date information retrieved from the data sources 102, 103, 104. The BI module 107, 108 may be a reporting tool that calculates whether certain KPI (i.e. a business target parameter) are met and may signal differences in planning and actuals. The signals of the BI module a re processed by the ASE platform 201 and are graphically shown on a display. The user will then notice these differences and may decide to act. If the user decides to act, the Integrator 204 receives a command from the ASE platform 201 indicating that the user asked for action to decrease a difference between a value of a business target parameter and a value of a realization parameter (i.e. actual performance). Alternatively, the Integrator 204 may receive the command directly from the business intelligence module 107. By sending this command, the ASE platform 201 will activate a business action process in the Integrator 204 in order to automatically create the appropriate business actions. Which business actions need to be taken depends on the particular business model. A business model may constitute of a set of business rules that are stored in e.g. a repository (i.e. a database) 210. In an embodiment, the Integrator 204 itself fills the repository 210 with business rules. These business rules are defined by the user that can use the I/O functionality of the ASE platform 201 or of the Integrator 204 to enter the business rules into the business analysis system 200.

Contrary to common ETL tools, the Integrator 204 is arranged to communicate directly to the business applications managing these databases 102, 104. In this example, the Integrator 204 communicates with an ERP application 205 and with a CRM application 206. To communicate with the business applications, the Integrator 204 may use several standard techniques such as XML, Web Services and ActiveX Data Objects (ADO). Communication on an ‘application level’ makes it possible that the business actions created by the Integrator 204 can be communicated to the business applications 205, 206 themselves. The business applications will process these actions into their associated databases 102, 104. Once the actions are processed by the appropriate business applications 205, 206, the BI modules 107, 108 will as soon as they request new data from the Virtual database 207, get business information in which the actions taken are processed. This loop of 1) displaying differences between planning and actuals 2) initiate appropriate actions 3) automatically perform those actions 4) store consequences of those actions into the appropriate databases 5) retrieve up-to-date business information, is referred to as ‘Actionable Business Intelligence’.

It is noted that, comparable to common ETL tools, the Integrator 204 may also connect directly to the external data source s (e.g. ERP database 102).

The data manipulation can be done with or without user interaction. Business processes are broken down into separate steps by the user and based on certain rules; these steps will be carried out by the Integrator 204. A business process needs parameters to run. These business parameters can be retrieved from a business model data source (not shown) or they can be entered by the user. The Integrator 204 may use different types of data sources to read from and to write back into.

These may vary from SQL databases like Oracle and Microsoft SQL Server to Open Source varieties like MySQL. The Integrator 204 may also use virtual sources like web services or other XML streams. To use as a data source as well as to expose functionality to the BI modules 107, 108 as the virtual data source 207 mentioned above.

Due to the use of several communication techniques, such as XML/web services/ADO, the Integrator 204 connects perfectly to different types of BI modules 107, 108. If the BI modules 107, 108 are not capable of generating input screens, the Integrator 204 may generate the input screens for them.

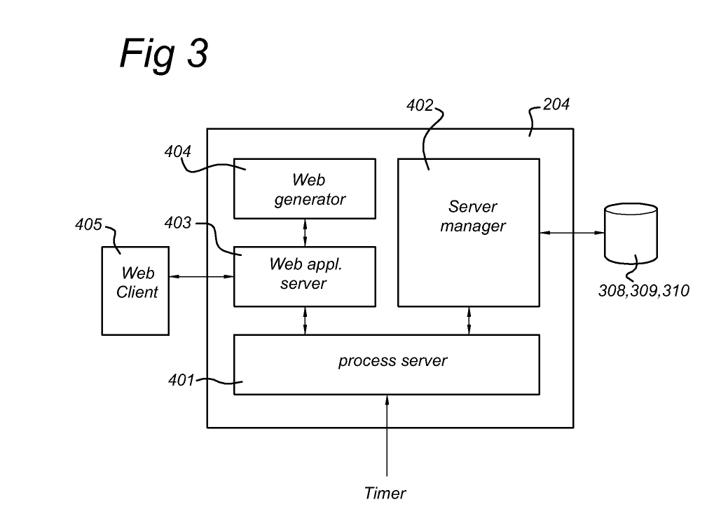

FIG. 3 shows the main components of the Integrator 204. The Integrator 204 comprises a Process Server 401, a Server Manager 402, a Web Application Server 403 and a Web Generator 404. The Process Server 401 is arranged to service processes of the Integrator 204. These processes are triggered either by a timer or by changes in a business data source, such as the ERP database 103 in FIG. 2. The Server Manager 402 is arranged to control the Process server 401 and the external resources (i.e. data sources 308, 309, 310). The Web Application Server 403 is arranged to connect the Process Server 401 to web clients 405 (browsers). The Web Application Server 403 may service (one-off) processes based on web service calls, generate input XML documents (files and streams), and generate output XML documents (files and streams).

The Web Generator 404 is arranged to connect to the Web Application Server 403. The Web Generator 404 enables the design of business processes and business models by the user by way of a ‘drag & drop’ -functionality. It is further arranged to generate Web Forms and to process the Web Forms. These Web forms are used to display information when the BI modules 107, 108 lack this functionality or take (additional) user input to start a business process.

The Integrator 204 may use classic and modern software techniques to get the input needed (data sources 102, 103, 104), generate screens (user interaction) and create results. Some of the possible techniques are listed below:

XML input streams (including web services)

Fits into an Service Oriented Architecture (SOA)

Generates SOA components from existing legacy systems

ADO/ODBC input an d output

XML output streams (including web services)

File input (XML, CSV)

OCX/(B)API support (for example SAP, Microsoft Exchange)

File Output (XML, CSV)

MAPI support (email)

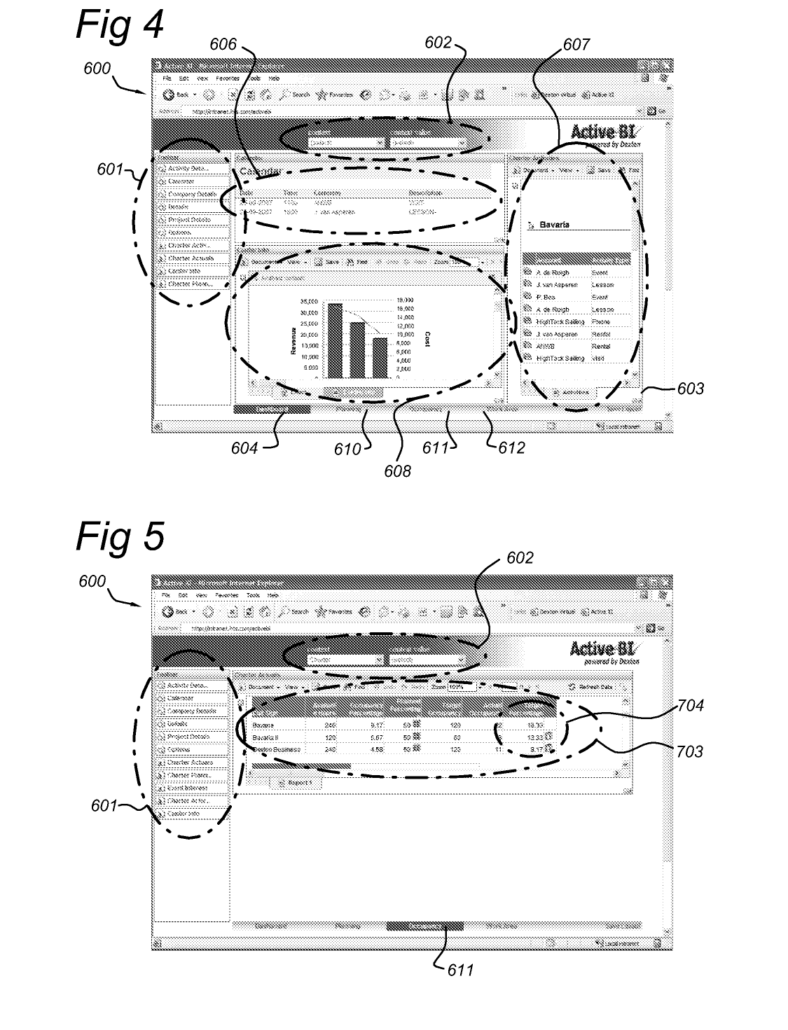

Now the working of the interaction with the user is discussed by way of an example. At the beginning of a session, the user will have to logon to the system. The user will need to enter some sort of ID which is used by the software platform 201 of the analysis system 200 for authentication of the user. The software platform 201 will check if the particular user is authorized to generate actions in the analysis system 200. After identifying the user, the user interface (screens) is composed using settings given by the user. Once the user has logged on, he will see for example a screen 600 as shown in FIG. 4. The screen 600 comprises a Toolbar section 601, a Context Selection section 602 and a main section 603 that is implemented as a plurality of tabs. In the example of FIG. 4, a tab called ‘Dashboard’ tab 604 is shown/selected. In this example, business data is shown relating to a charter (i.e. boat) rental company. The company has multiple sailing centers and each sailing center stations a number of charters. The dashboard tab 604 shows a calendar 606, a list 607 of outstanding charter activities for a charter called ‘Bavaria’, and some detailed information about the performance of a sailing centre, see Center info 608.

The software platform 301 is manages all the screen elements needed to do the day-to-day operational tasks varying from analysis to contact management. In this example the Toolbar section 601 and the Context Selection section 602 are managed by the software platform 301. The Context Selection section offers the possibility to select user definable contexts that help going though the day-to-day work. A user can have specific contexts, for example a marketing planner could have typical contexts such as:

projects

area's

target groups.

In this example, the user is a planner for the charter rental company, and his specific contexts are:

charter

(sail-) center.

The various tools inside the toolbox are dependant on the context. Choosing a different context in the Context Selection section 602, will display the appropriate tools in the Toolbar section 601 to carry out the tasks at hand. Within the context, there can be multiple ways or areas of looking at the information. These are setup as tabs at the main section 603 of the screen 600. Next to the tab 604 for the dashboard (homepage), a Planning tab 610, an Occupancy tab 611 and a Work area tab 612 for ad-hoc tasks. Each tab may have multiple components on it. These components are selected based on the tools and (pre-) defined user settings. In this example, the user has placed a calendar component 606 on the screen 600, which is an ASE component and is the result of a specific process being run when building up the screen contents (show all the relevant activities for the current user). The other components shown (i.e. 607, 608) are elements of a Business Intelligence module (e.g. Business Objects XI R2). All of these components work together within the selected context. So changing a context value (e.g. selecting a different sailing center) will adjust the component contents accordingly.

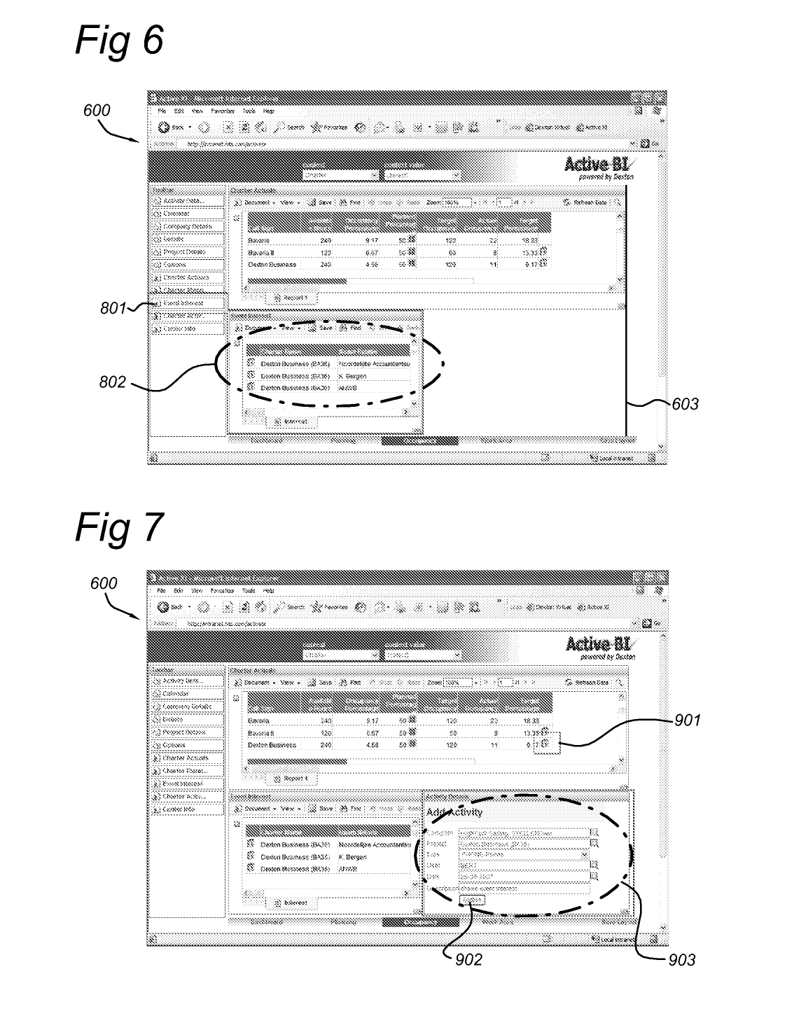

In FIG. 5, the screen 600 shows a situation in which the user has selected the context ‘Charter’. Now a ‘Charter Actuals’ component 703 within the context of charters on the occupancy tab 611 shows a table in which a target percentage against each charter is listed (see last column 704 of the table). This target percentage may be calculated based on the realized turnover as well as on the projected turnover based on orders and quotations. Once the context of ‘Charter’ is selected from the context selection section 602, the appropriate KPI's are calculated based on the information retrieved from the business data sources 102, 103, 104. When a particular KPI is not met for a particular charter, an additional icon is placed next to the target percentage in the table of the Charter Actuals component 703. This additional icon tells the user that the associated KPI is not met. In this example, the planner will notice that for 2 charters, the target percentage has fallen short of the minimum of 15 and is therefore marked with an extra icon. To get further insight into the reasons behind these numbers, the user may choose a component from the Toolbar section 601 to see if anyone has shown an interest in any of the charters. Therefore he can select the option ‘Event Interest’ 801 and drag it on to the main section 603 of the screen 600, see FIG. 6. Now he can see that even although the KPI for the charter called ‘Dexton Business’ is short of the target (i.e. the KPI is not met), there is an interest in this charter by several prospects, see Event Interest component 802. Information about interest for a particular charter can be obtained from response information stored in for example a CRM system. The user may now decide to take action by starting an appropriate business process. The user will click on the icon 901 and as a result an ‘Add activity’ component 902 is shown. The Add activity component 902 shows the additional input needed to start a process from the Agile System Environment 201. The business processes are defined using the result of e.g. a business process analysis performed by e.g. business analysts. These defined business processes are modeled and stored into the integrator repository 210. Once the business process is defined, the Integrator 204 will show the corresponding component with the input fields it needs to carry out the business process. The user can check the results and adjust values. Upon pressing the ‘OK button’ 903, a business process is automatically started (‘is kicked-off’) in which one or more necessary actions are executed by the analysis system 300. Because of the business rules within the company of the example, the necessary actions are informing someone from the sales department and telling them to chase one or more quotes. In this case, the analysis system 300 will automatically place an activity (e.g. make a phone call) in the task list of a specific user to chase this quote (i.e. HighTack Sailing) and since this is an internal task, the activity is related to the internal company.

The necessary actions generated by the Integrator 204 are the result of a predefined business process entered by the user, and are in compliance with the company policy. The actions are communicated to the business software applications 205, 206 which will initiate the execution of one or more business processes. The results of these business processes are placed by the business software application 205, 206 in its corresponding data source 102, 104. A change in these data sources 102, 104 will then automatically, via the virtual database 207, update the results produced by the BI module 107.

Once the quote has been chased, result of this chase will automatically be ‘picked up’ by the KPI involved because this particular KPI is based on actual and targeted occupation of the charter. Since the targeted occupations for the charter ‘Dexton Business’ has now changed, the target percentage displayed in table of the Charter Actuals component 703 will change as well (not shown). The actual handling of the call activity by the sales department can be handled by a CRM-system. Alternatively, a process component may be created in/by the ASE platform 201 which will appear as an action in the Calendar component 606 on the dashboard tab 604 for the selected user.

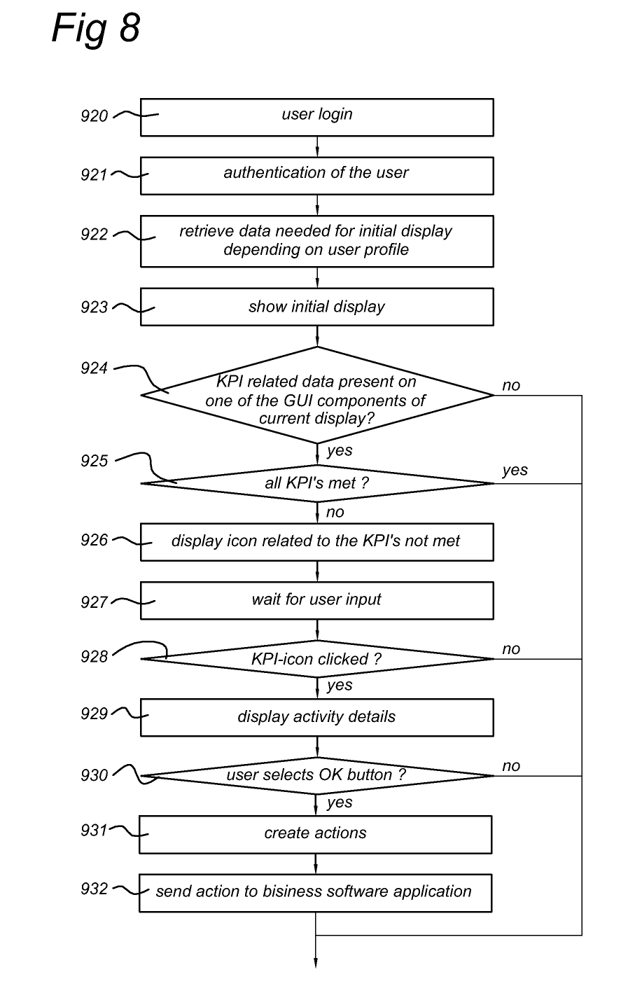

FIG. 8 is a flow chart showing a procedure performed by the system according to an embodiment of the invention. In a step 920 a user logs on to the system. The system will perform an authentication step 921 and will then retrieve data needed for an initial display depending on a user profile, see step 922. Then in a step 923, the initial display is shown on a (computer) screen, using for example Windows XP or any other suitable GUI known to the skilled person. If the current display (in this case the initial) shows components that output KPI related data, see step 924, a step 925 follows in which it is checked whether all KPI's concerned are met. If this is not the case, a step 926 follows in which KPI-icons (see e.g. icon 901 in FIG. 7) are displayed related to the particular KPI's. Then in a step 927, the system waits for input from the user. If one of the KPI-icons is clicked, see step 928, the system will display activity details in a step 929, see for example the Add activity component 902 in FIG. 7. In a step 930 it is checked whether the user has clicked the OK-button 903. If this is the case, then in a step 931 the necessary actions are created by the Integrator 204. These actions are sent to one of the business software application 205, 206 in a step 932.

The present invention h as been explained above with reference to a number of exemplary embodiments. As will be apparent to the person skilled in the art, various modifications and amendments can be made without departing from the scope of the present invention, as defined in the appended claims.

### LIST OF ABBREVIATIONS

ADO ActiveX Data Objects

CSV Character (comma) separated file

ERP Enterprise Resource Planning

GUI Graphical User Interface

ISAM Indexed Sequential Access Method

KPI Key Performance Indicator

ODBC Open Database Connectivity

VSAM Virtual Storage Access Method

XML Extended Markup Language

1-8. (canceled)

9. System (200) for analyzing and controlling a business process, comprising:
a software platform (201) for supporting at least one business intelligence module (107), said software platform (201) being arranged to provide an interface between a user and said at least one BI module (107);
an integration module (204) arranged to communicate with said software platform (201) and with said at least one business intelligence module (302), said integration module (204) being arranged to:
extract business data from at least one business data storage (102) source;
offer said business data to said at least one business intelligence module (107);
receive a command from said software platform (201) or from said business intelligence module (107) indicating that said user asked for action to decrease a difference between a value of a business target parameter and a value of a realization parameter;
create one or more appropriate business actions to decrease said difference using business rules already provided by said user;
communicate said one or more business actions to at least one business software application, such as an ERP application, in charge of said at least one business data storage.

10. System according to claim 9, wherein said one or more business actions are communicated to said at least one business software application by means of at least one of XML data files, XML data streams, CSV files and ADO/ODBC.

11. System according to claim 9, wherein said software platform (201) comprises a GUI component arranged to display said difference between a value of a business target parameter and a value of a realization parameter, and to receive a command from said user.

12. System according to claim 9, wherein said integration module is arranged to receive business rules and store said business rules into a repository.

13. System according to claim 9, wherein said integration module is arranged to store said business data into a computer memory.

14. System according to claim 9, wherein said integration module is arranged to extract business data from said at least one business data storage (102) source after a request from said at least one BI module (107).

15. Method for analyzing and controlling a business process, comprising:
provide a software platform (201) to support at least one BI module (107);
provide an interface between a user and said at least one BI module (107);
extract business data from at least one business data storage (102) source;
offer said business data to said at least one business intelligence module (107);
receive a command from said or from said business intelligence module (107) indicating that a user asked for action to decrease a difference between a value of a business target parameter and a value of a realization parameter;
create one or more appropriate business actions to decrease said difference using business rules already provided by said user;
communicate said one or more business actions to at least one business software application, such as an ERP application, in charge of said at least one business data storage.

16. Computer program product tangibly embodied in an information carrier, the product including instructions that, when executed, perform the method according to claim 15.
